(19) United States
(12) Patent Application Publication
(10) Pub. No.: US 2007/0213434 A1
(43) Pub. Date: Sep. 13, 2007

(54) Process for the preparation of mineral filled polyamide and polyester compositions exhibiting increased melt flow and articles formed therefrom

(76) Inventor: Avelino F. Lima, North Hills, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/715,722

(22) Filed: Mar. 8, 2007

Related U.S. Application Data
(60) Provisional application No. 60/781,493, filed on Mar. 11, 2006.

(51) Int. Cl. C08K 5/15; C08K 5/12

(52) U.S. Cl. 524/112; 524/425; 524/295

(57) ABSTRACT

A process for the preparation of mineral filled polyamide and polyester compositions having increased melt flow, in which polyamide or polyester is melt-blended with at least one aromatic carboxylic acid and/or anhydride, mineral filler, and optionally, one or more additional components, wherein the aromatic carboxylic acid and/or anhydride has a melting point that is no greater than the onset temperature of the melting point endotherm of the polyamide or polyester.

### CROSS REFERENCE TO RELATED APPLICATIONS

This application claims the benefit of priority to U.S. Provisional Application No. 60/781,493, filed Mar. 11, 2006.

### FIELD OF THE INVENTION

The present invention relates to a process for the preparation of mineral-filled polyamide and polyester compositions that exhibit increased melt flow.

### BACKGROUND OF THE INVENTION

High melt flow (or low melt viscosity, as these terms are used interchangeably) is a very desirable characteristic of a melt-processable polymer resin composition, as it allows for greater ease of use in processes such as injection molding. A composition with higher melt flow or lower melt viscosity can be injection molded with greater ease compared to another resin that does not possess this characteristic. Such a composition has the capability of filling a mold to a much greater extent at lower injection pressures and temperatures and a greater capability to fill intricate mold designs with thin cross-sections. For a linear polymer there is generally a positive correlation between polymer molecular weight and melt viscosity.

It is also often desirable to add mineral fillers to achieve desired physical properties. However, the presence of mineral fillers often leads to an increase in the melt viscosity of the resulting resin. Furthermore, the fillers are typically added using a melt blending process, and will preferably be sufficiently well dispersed in the polymer matrix to obtain optimal physical properties. The dispersal of the components during melt blending will often occur more efficiently when the polymer matrix has a high melt viscosity, and thus it is often desirable to select a polymer matrix having such a high melt viscosity for use in preparing filled compositions.

Therefore, a method of preparing mineral-filled polyamide or polyester compositions having improved melt flow would be desirable. Furthermore, it would be desirable to produce such compositions in the presence of reactive mineral fillers, such as calcium carbonate, that might react with many flow enhancers.

### SUMMARY OF THE INVENTION

Disclosed and claimed herein is a process for the preparation of a mineral-reinforced composition exhibiting high melt flow, comprising melt-blending a thermoplastic polymer comprising at least one polyamide and/or at least one polyester with about 0.1 to about 10 weight percent, based on the total weight of polyamide and/or polyester, of at least one aromatic dicarboxylic acid, aromatic dicarboxylic acid anhydride, aromatic tricarboxylic acid, and/or aromatic tricarboxylic acid anhydride with at least one mineral filler; and optionally, with one or more additional components, wherein the aromatic dicarboxylic acid, aromatic dicarboxylic acid anhydride, aromatic tricarboxylic acid, and/or aromatic tricarboxylic acid anhydride has a melting point that is no greater than the onset temperature of the melting point endotherm of the polyamide or polyester

### DETAILED DESCRIPTION OF THE INVENTION

A process is provided for the preparation of mineral filled polyamide and polyester compositions that have improved melt flow. The process comprises melt blending polyamide and/or polyester with at least one aromatic dicarboxylic acid, aromatic dicarboxylic acid anhydride, aromatic tricarboxylic acid, and/or aromatic tricarboxylic anhydride (referred to herein as the “aromatic carboxylic acid and/or anhydride”), at least one mineral filler, and optionally, one or more additional components, wherein the aromatic carboxylic acid and/or anhydride has a melting point that is no greater than the onset temperature of the melting point endotherm of the polyamide or polyester.

The polyamide used in the process of the present invention is at least one thermoplastic polyamide. Suitable polyamides can be condensation products of dicarboxylic acids and diamines, and/or aminocarboxylic acids, and/or ring-opening polymerization products of cyclic lactams. Suitable dicarboxylic acids include, but are not limited to, adipic acid, azelaic acid, sebacic acid, dodecanedioic acid, isophthalic acid, and terephthalic acid. Suitable diamines include, but are not limited to, tetramethylenediamine, hexamethylenediamine, octamethylenediamine, nonamethylenediamine, dodecamethylenediamine, decamethylenediamine, 2-methylpentamethylenediamine, 2-methyloctamethylenediamine, trimethylhexamethylenediamine, bis(p-aminocyclohexyl)methane, m-xylylenediamine, and p-xylylenediamine. A suitable aminocarboxylic acid is 11-aminododecanoic acid. Suitable cyclic lactams are caprolactam and laurolactam. Preferred polyamides include aliphatic polyamides such as polyamide 6; polyamide 6,6; polyamide 4,6; polyamide 6,10; polyamide 6,12; polyamide 11; polyamide 12; and semi-aromatic polyamides such as poly(m-xylylene adipamide) (polyamide MXD,6), poly(dodecamethylene terephthalamide) (polyamide 12,T), poly(decamethylene terephthalamide) (polyamide 10,T), poly(nonamethylene terephthalamide) (polyamide 9,T), hexamethylene adipamide/hexamethylene terephthalamide copolyamide (polyamide 6,T/6,6), hexamethylene terephthalamide/2-methylpentamethylene terephthalamide copolyamide (polyamide 6,T/D,T); and copolymers and mixtures of these polymers. The polyamides may be amorphous polyamides or semicrystalline. An example of a suitable amorphous polyamide includes hexamethylene terephthalamide/hexamethylene isophthalamide copolymer.

The polyester used in the process of the present invention is at least one thermoplastic polyester. Preferred polyesters include polyesters having an inherent viscosity of 0.3 or greater and that are, in general, linear saturated condensation products of diols and dicarboxylic acids, or reactive derivatives thereof. Preferably, they will comprise condensation products of aromatic dicarboxylic acids having 8 to 14 carbon atoms and at least one diol selected from the group consisting of neopentyl glycol, cyclohexanedimethanol, 2,2-dimethyl-1,3-propane diol and aliphatic glycols of the formula HO(CH₂)ₙOH where n is an integer of 2 to 10. Up to 20 mole percent of the diol may be an aromatic diol such as ethoxylated bisphenol A, sold under the tradename Dianol 220 by Akzo Nobel Chemicals, Inc.; hydroquinone; biphenol; or bisphenol A. Up to 50 mole percent of the aromatic dicarboxylic acids can be replaced by at least one different aromatic dicarboxylic acid having from 8 to 14 carbon atoms, and/or up to 20 mole percent can be replaced by an aliphatic dicarboxylic acid having from 2 to 12 carbon atoms. Copolymers may be prepared from two or more diols or reactive equivalents thereof and at least one dicarboxylic acid or reactive equivalent thereof or two or more dicarboxylic acids or reactive equivalents thereof and at least one diol or reactive equivalent thereof. Difunctional hydroxy acid monomers such as hydroxybenzoic acid or hydroxynaphthoic acid may also be used.

Preferred polyesters include poly(ethylene terephthalate) (PET), poly(1,4-butylene terephthalate) (PBT), poly(propylene terephthalate) (PPT), poly(1,4-butylene naphthalate) (PBN), poly(ethylene naphthalate) (PEN), poly(1,4-cyclohexylene dimethylene terephthalate) (PCT), and copolymers and mixtures of the foregoing. Also preferred are 1,4-cyclohexylene dimethylene terephthalate/isophthalate copolymer and other linear homopolymer esters derived from aromatic dicarboxylic acids, including isophthalic acid; bibenzoic acid; naphthalenedicarboxylic acids including the 1,5-, 2,6-, and 2,7-naphthalenedicarboxylic acids; 4,4′-diphenylenedicarboxylic acid; bis(p-carboxyphenyl)methane; ethylene-bis-p-benzoic acid; 1,4-tetramethylene bis(p-oxybenzoic) acid; ethylene bis(p-oxybenzoic) acid; 1,3-trimethylene bis(p-oxybenzoic) acid; and 1,4-tetramethylene bis(p-oxybenzoic) acid, and glycols selected from the group consisting of 2,2-dimethyl-1,3-propane diol; neopentyl glycol; cyclohexane dimethanol; and aliphatic glycols of the general formula HO(CH₂)ₙOH where n is an integer from 2 to 10, e.g., ethylene glycol; 1,3-trimethylene glycol; 1,4-tetramethylene glycol;-1,6-hexamethylene glycol; 1,8-octamethylene glycol; 1,10-decamethylene glycol; 1,3-propylene glycol; and 1,4-butylene glycol. Up to 20 mole percent, as indicated above, of repeat units derived from one or more aliphatic acids, including adipic, sebacic, azelaic, dodecanedioic acid or 1,4-cyclohexanedicarboxylic acid can be present. Also preferred are copolymers derived from 1,4-butanediol, ethoxylated bisphenol A, and terephthalic acid or reactive equivalents thereof. Also preferred are random copolymers of at least two of PET, PBT, and PPT, and mixtures of at least two of PET, PBT, and PPT, and mixtures of any of the foregoing.

The polyester may also be in the form of copolymers that contain poly(alkylene oxide) soft segments. The poly(alkylene oxide) segments may be present in about 1 to about 15 parts by weight per 100 parts per weight of polyester. The poly(alkylene oxide) segments preferably have a number average molecular weight in the range of about 200 to about 3,250 or, more preferably, in the range of about 600 to about 1,500. Preferred copolymers contain poly(ethylene oxide) incorporated into a PET or PBT chain. Methods of incorporation are known to those skilled in the art and can include using the poly(alkylene oxide) soft segment as a comonomer during the polymerization reaction to form the polyester. PET may be blended with copolymers of PBT and at least one poly(alkylene oxide). A poly(alkylene oxide) may also be blended with a PET/PBT copolymer. The inclusion of a poly(alkylene oxide) soft segment into the polyester portion of the composition may accelerate the rate of crystallization of the polyester.

The aromatic carboxylic acid and/or anhydride used in the process of the present invention is chosen such that its melting point is no greater than the onset temperature of the melting point endotherm of the polyamide or polyester.

By “aromatic dicarboxylic acid” is meant an organic compound in which at least two carboxylic acid moieties are bonded to an aromatic ring. By “aromatic dicarboxylic acid anhydride” is meant the dicarboxylic acid anhydride of an organic compound in which at least two carboxylic acid moieties are bonded to an aromatic ring. By “aromatic tricarboxylic acid” is meant an organic compound in which at least three carboxylic acid moieties are bonded to an aromatic ring. By “aromatic tricarboxylic acid anhydride” is meant the dicarboxylic acid anhydride of an organic compound in which at least three carboxylic acid moieties are bonded to an aromatic ring.

As used herein in reference to the aromatic carboxylic acid and/or anhydride, the term “melting point” refers to sublimation point or decomposition point if the organic acid does not have a melting point. Examples of suitable aromatic carboxylic acids and/or anhydrides include phthalic acid, phthalic anhydride, and trimellitic anhydride.

By “onset temperature of the melting point endotherm” of the polyamide or polyester is meant the extrapolated onset temperature of the melting curve of the polyamide or polyester (T_{f}) as measured by differential scanning calorimetry (DSC) following ASTM method D3418—82 (Reapproved 1988). If the polyamide or polyester has two or more melting point endotherms, the onset temperature of the lowest melting point endotherm is selected. If two or more polyamides or polyesters are used, the onset temperature of the melting point endotherm of the polyamide or polyester with the lowest melting point endotherm onset temperature is chosen.

The aromatic carboxylic acid and/or anhydride is used at about 0.01 to about 10 weight percent, preferably at about 0.05 to about 2 weight percent, or more preferably at about 0.1 to about 1 weight percent, where the weight percentages are based on the total weight of polyamide or polyester.

The amount of polyamide or polyester plus aromatic carboxylic acid and/or anhydride used is preferably about 40 to about 95 weight percent, or more preferably about 50 to about 90 weight percent, or yet more preferably about 60 to about 85 weight percent, based on the total weight of polyamide and/or polyester, mineral filler, aromatic carboxylic acid and/or anhydride, and optional additional components.

The mineral filler may be any non-fibrous mineral, and may be flaky, platy, granular, spheroidal, cubic, tubular, denditric, elongated, and irregular. By the term “fibrous” is meant a material having a fibrous or needlelike form and a number average aspect ratio of at least about 5. Examples of suitable fillers include calcium carbonate, talc, mica, calcined clay, magnesium sulfate, lizardite, ceramic beads, fumed silica, wollastonite, calcium hydroxide, barite, feldspar, graphite, perlite, vermiculite, and attapulgite. The amount of mineral filler used is preferably about 5 to about 60 weight percent, or more preferably about 10 to about 50 weight percent, or yet more preferably about 15 to about 40 weight percent, based on the total weight of polyamide and/or polyester, mineral filler, aromatic carboxylic acid and/or anhydride, and optional additional components.

The optional additional components used in the process of the present invention can include fibrous reinforcing agents having an aspect ratio of greater than about 3. Examples of suitable reinforcing agents include glass fibers, carbon fibers, wollastonite, aramids, aluminum borate whiskers, and the like. When present, the amount of reinforcing agent used is preferably about 5 to about 50 weight percent, or more preferably about 10 to about 40 weight percent or yet more preferably about 15 to about 30 weight percent, based on the total weight of polyamide and/or polyester, mineral filler, aromatic carboxylic acid and/or anhydride, reinforcing agent, and optional additional components.

Other optional additional components used in the process of the present invention can include one or more of impact modifiers, plasticizers, thermal stabilizers, oxidative stabilizers, UV light stabilizers, flame retardants, chemical stabilizers, lubricants, mold-release agents, colorants (such as carbon black and other dyes and pigments), nucleating agents, nanoclays, and the like.

In the process of the present invention, the polyamide or polyester and organic acid and optional additional ingredients are melt-blended. All of the components may be dry-blended prior to melt-blending; previously melt-blended mixtures of polyamide or polyester with mineral filler may be melt-blended with the aromatic carboxylic acid and/or anhydride; previously melt-blended mixtures of polyamide or polyester with mineral filler may be melt-blended with the aromatic carboxylic acid and/or anhydride and additional additives.

Melt-blending may be carried out using any appropriate method known to those skilled in the art. Suitable methods may include using a single or twin-screw extruder, blender, kneader, Banbury mixer, molding machine, etc. Twin-screw extrusion is preferred.

The compositions made from the process of the present invention have a high melt flow and may be conveniently formed into a variety of articles using injection molding, rotomolding and other melt-processing techniques.

Examples of articles include computer housings, fans and fan shrouds, wheel covers, and housings, such as switch housings.

The process of the present invention is advantageous in that it surprisingly provides a method for producing mineral-reinforced polyamide and polyester compositions having high melt flow. The process is particularly advantageous in that it further surprisingly provides a method for producing polyamide and polyester compositions having good melt flow in the presence of reactive mineral fillers such as calcium carbonate that might be expected to react significantly with the aromatic acid and/or anhydride used in the process.

### EXAMPLES

### Preparation of the Compositions

The ingredients shown in Tables 1, 2, 4, and 5 were melt-blended in nine-barrel extruders and all ingredients were added to the barrel furthest from the die, except for glass fibers and mineral fillers, which were added to the 6^{th} barrel from the feed throat. The temperature of the 2^{nd} barrel from the feed throat was set at about 280° C. and the remaining barrels were set at about 300° C. The die temperature was set at about 310° C. The compositions in Table 1 were compounded in a 40 mm Werner & Pfleiderer co-rotating twin extruder at a rate of about 150 pounds/hour. The compositions shown in Table 2 were compounded in a 58 mm co-rotating twin extruder at a rate of about 400 pounds/hour.

In the case of Examples A-K (Table 5), compositions were prepared by melt blending in a twin screw extruder polyamides both in the absence (to produce control compositions) and presence of a series of carboxylic acid compounds (including carboxylic acid anhydrides). The compositions were prepared by melt blending 25 weight percent of the mineral filler shown in the table; 15 weight percent glass fibers; 0.25 weight percent Irgafos® 168; 0.5 weight percent Naugard® 445; 1.54 weight percent carbon black concentrate; and 0.6 weight percent nigrosine concentrate with the polyamide(s) indicated in the table and, optionally, the carboxylic acid compound shown in the table. When the carboxylic acid compound was used, it was added in 0.3 weight percent and the polyamide(s) was (were) added in 56.81 weight percent. When no carboxylic acid compound was used, the polyamide(s) was (were) added in 57.11 weight percent. In the case of Examples A, D, E, G, H, and I, blends of two polyamide were used and the relative weight ratios of each is indicated in the table. The melt viscosities of the resulting compositions that had been prepared without the use of a carboxylic acid compound were measured and are given in Table 5 as “MV with no carboxylic acid compound.” The melt viscosities of the corresponding compositions prepared with the use of a carboxylic acid compound were measured and the results for each composition are reported in Table 1 as a percentage of the MV of the composition that was prepared without using a carboxylic acid compound. A reduction of the MV to less than or equal to about 85% of that of the control composition is desirable. An increase of the MV to greater than or equal to about 115% of that of the control composition is very undesirable. Compositions made using phthalic acid, phthalic anhydride, or trimellitic anhydride are within the scope of the invention.

The components shown in Tables 1, 2, 4, and 5 are as follows:
Polyamide A refers to Ultramid® B3, a polyamide 6 having a first heat melting point of about 223° C. produced by BASF.
Polyamide B refers to Zytel®101 NC010, a polyamide 6,6 having a first heat melting point of about 263° C. produced by DuPont.
Polyamide C refers to Zytel® FE3365 NC010, a polyamide 6/6,6 copolymer having a first heat melting point of about 237° C. produced by DuPont.
Polyamide D refers to Zytel® FE3667 NC010, a polyamide 6,10 having a first heat melting point of about 224° C. produced by Du Pont.
Polyamide E refers to HTN 503, an amorphous polyamide produced by Du Pont and having a glass transition temperature of about 125° C.
Calcium carbonate (CaCO₃) A refers to Vicron® 41-8, available from Specialty Minerals and having a median particle size of 8.0 μm.
Calcium carbonate B refers to Vicron® 15-15, available from Specialty Minerals and having a median particle size of 3.5 μm.
Wollastonite refers to Nyad® 475, a wollastonite having a number average aspect ratio of about 3 supplied by Nyco Minerals, Inc., Willsboro, N.Y.
Kaolin refers to Satintone Special, supplied by Engelhard Corp., Iselin, N.J.
Glass fibers refers to Vetrotex® 983, available from Saint Gobain.
Irgafos® 168 refers to tris-(2-4-di-tert-butylphenyl)phosphite from Ciba-Geigy Specialties.
Naugard® 445 refers to 4,4′-di-(α,α-dimethylbenzyl)diphenylamine, available from Crompton.
Carbon black concentrate refers to 35 weight percent of carbon black melt-dispersed in ethylene/methyl acrylate.
Nigrosine concentrate refers to 40 weight percent of nigrosine melt-dispersed in polyamide 6.
Silane refers to gamma-aminopropyltriethoxysilane.

### Test Methods

Apparent melt viscosity (MV) was measured at a shear rate of 1000 sec⁻¹ and 280° C. in accordance with ASTM D3835 or ISO 11443.
Tensile strength at break and elongation at break were measured at 5 mm/min according to ISO 527.
Notched Charpy impact strength was measured according to ISO 179.
Tensile modulus was measured according to ISO 527.
Heat deflection temperature at 1.8 MPa was measured according to ISO 75.
Melting point was measured according to ISO11357.

TABLE 1

| | | | | | Comp. | | Comp. | Comp. | Comp. | Comp. | Comp. | Comp. |
|---|---|---|---|---|---|---|---|---|---|---|---|---|
| | Ex. 1 | Ex. 2 | Ex. 3 | Comp. Ex. 1 | Ex. 2 | Comp. Ex. 3 | Ex. 4 | Ex. 5 | Ex. 6 | Ex. 7 | Ex. 8 | Ex. 9 |
| Polyamide A | 42.53 | — | — | 42.83 | — | — | 42.53 | — | — | 42.53 | — | — |
| Polyamide B | — | 41.81 | — | — | 42.11 | — | — | 41.81 | — | — | 41.81 | — |
| Polyamide C | — | — | 41.81 | — | — | 42.11 | — | — | 41.81 | — | — | 41.81 |
| Polyamide D | 14.28 | — | — | 14.28 | — | — | 14.28 | — | — | 14.28 | — | — |
| Polyamide E | — | 15 | 15 | — | 15 | 15 | — | 15 | 15 | — | 15 | 15 |
| Calcium carbonate A | 25 | 25 | 25 | 25 | 25 | 25 | 25 | 25 | 25 | 25 | 25 | 25 |
| Glass fibers | 15 | 15 | 15 | 15 | 15 | 15 | 15 | 15 | 15 | 15 | 15 | 15 |
| Carbon black | 1.54 | 1.54 | 1.54 | 1.54 | 1.54 | 1.54 | 1.54 | 1.54 | 1.54 | 1.54 | 1.54 | 1.54 |
| concentrate. | | | | | | | | | | | | |
| Nigrosine concentrate. | 0.6 | 0.6 | 0.6 | 0.6 | 0.6 | 0.6 | 0.6 | 0.6 | 0.6 | 0.6 | 0.6 | 0.6 |
| Irgafos ® 168 | 0.25 | 0.25 | 0.25 | 0.25 | 0.25 | 0.25 | 0.25 | 0.25 | 0.25 | 0.25 | 0.25 | 0.25 |
| Naugard ® 445 | 0.5 | 0.5 | 0.5 | 0.5 | 0.5 | 0.5 | 0.5 | 0.5 | 0.5 | 0.5 | 0.5 | 0.5 |
| Phthalic anhydride | 0.3 | 0.3 | 0.3 | — | — | — | — | — | — | — | — | — |
| Adipic acid | — | — | — | — | — | — | 0.3 | 0.3 | 0.3 | — | — | — |
| Terephthalic acid | — | — | — | — | — | — | — | — | — | 0.3 | 0.3 | 0.3 |
| Melt Point, 1^{st} cycle, | 224 | 262 | 234 | 223 | 263 | 235 | 224 | 262 | 235 | 224 | 258 | 236 |
| (° C.) | | | | | | | | | | | | |
| Melt viscosity (P · s) | 109 | 203 | 206 | 211 | 267 | 240 | 153 | 235 | 251 | 230 | 287 | 272 |
| Tensile strength (MPa) | 126 | 131 | 126 | 116 | 119 | 127 | 116 | 131 | 126 | 118 | 127 | 126 |
| Elongation at Break (%) | 2.8 | 3.0 | 2.9 | 2.8 | 2.5 | 2.9 | 2.8 | 2.8 | 2.9 | 2.6 | 2.8 | 3.1 |
| Tensile Modulus (GPa) | 7.43 | 7.75 | 7.20 | 7.29 | 7.58 | 7.29 | 7.44 | 7.48 | 7.47 | 7.49 | 7.35 | 7.13 |
| Notched Charpy impact | 4.56 | 3.98 | 3.93 | 5.58 | 4.00 | 4.14 | 4.74 | 3.69 | 4.25 | 4.14 | 3.72 | 4.16 |
| strength (KJ/m²) | | | | | | | | | | | | |
| Heat Distortion | 200 | 206 | 152 | 194 | 210 | 112 | 197 | 218 | 108 | 198 | 109 | 117 |
| Temperature at 1.82 MPa | | | | | | | | | | | | |
| (° C.) | | | | | | | | | | | | |

Ingredient quantities are given in weight percent based on the total weight of the composition.

TABLE 2

| | | | | | Comp. | Comp. | Comp. | Comp. | Comp. | Comp. | Comp. | Comp. |
|---|---|---|---|---|---|---|---|---|---|---|---|---|
| | Ex. 4 | Ex. 5 | Ex. 6 | Ex. 7 | Ex. 10 | Ex. 11 | Ex. 12 | Ex. 13 | Ex. 14 | Ex. 15 | Ex. 16 | Ex. 17 |
| Polyamide A | 42.5 | 42.5 | 42.5 | 42.5 | 42.8 | 42.8 | 42.5 | 42.5 | 42.5 | 42.5 | 42.5 | 42.5 |
| Polyamide D | 14.3 | 14.3 | 14.3 | 14.3 | 14.3 | 14.3 | 14.3 | 14.3 | 14.3 | 14.3 | 14.3 | 14.3 |
| Calcium carbonate A | 25 | — | 25 | — | 25 | — | 25 | — | 25 | — | 25 | — |
| Calcium carbonate B | — | 25 | — | 25 | — | 25 | — | 25 | — | 25 | — | 25 |
| Glass fibers | 15 | 15 | 15 | 15 | 15 | 15 | 15 | 15 | 15 | 15 | 15 | 15 |
| Carbon black | 1.54 | 1.54 | 1.54 | 1.54 | 1.54 | 1.54 | 1.54 | 1.54 | 1.54 | 1.54 | 1.54 | 1.54 |
| concentrate. | | | | | | | | | | | | |
| Nigrosine concentrate. | 0.6 | 0.6 | 0.6 | 0.6 | 0.6 | 0.6 | 0.6 | 0.6 | 0.6 | 0.6 | 0.6 | 0.6 |
| Irgafos ® 168 | 0.25 | 0.25 | 0.25 | 0.25 | 0.25 | 0.25 | 0.25 | 0.25 | 0.25 | 0.25 | 0.25 | 0.25 |
| Naugard ® 445 | 0.5 | 0.5 | 0.5 | 0.5 | 0.5 | 0.5 | 0.5 | 0.5 | 0.5 | 0.5 | 0.5 | 0.5 |
| Phthalic anhydride | 0.3 | 0.3 | — | — | — | — | — | — | — | — | — | — |
| Phthalic acid | — | — | 0.3 | 0.3 | — | — | — | — | — | — | — | — |
| Maleic anhydride | — | — | — | — | — | — | 0.3 | 0.3 | — | — | — | — |
| Maleic acid | — | — | — | — | — | — | — | — | 0.3 | 0.3 | — | — |
| Fumaric acid | — | — | — | — | — | — | — | — | — | — | 0.3 | 0.3 |

Ingredient quantities are given in weight percent based on the total weight of the composition.

TABLE 3

| | | | | | Comp. | Comp. | Comp. | Comp. | Comp. | Comp. | Comp. | Comp. |
|---|---|---|---|---|---|---|---|---|---|---|---|---|
| | Ex. 4 | Ex. 5 | Ex. 6 | Ex. 7 | Ex. 10 | Ex. 11 | Ex. 12 | Ex. 13 | Ex. 14 | Ex. 15 | Ex. 16 | Ex. 17 |
| Melt Point, 1^{st} cycle | 224 | 224 | 224 | 225 | 224 | 223 | 224 | 224 | 223 | 224 | 223 | 224 |
| Melt viscosity | 103 | 139 | 162 | 151 | 195 | 207 | 256 | 93 | 227 | 244 | 198 | 214 |
| (P · s) | | | | | | | | | | | | |
| Elongation at Break, | 2.7 | 2.6 | 2.7 | 2.7 | 2.6 | 2.7 | 2.7 | 2.9 | 2.7 | 2.9 | 2.5 | 2.6 |
| (%) | | | | | | | | | | | | |
| Tensile strength | 117 | 121 | 118 | 121 | 119 | 123 | 119 | 122 | 119 | 124 | 119 | 124 |
| (MPa) | | | | | | | | | | | | |
| Tensile modulus | 7.24 | 7.19 | 7.28 | 7.23 | 7.44 | 7.40 | 7.27 | 7.25 | 7.39 | 7.46 | 7.56 | 7.61 |
| (GPa) | | | | | | | | | | | | |
| Notched Charpy | 4.31 | 5.13 | 4.62 | 4.79 | 4.66 | 5.15 | 4.78 | 5.67 | 4.96 | 5.69 | 4.14 | 5.17 |
| impact strength | | | | | | | | | | | | |
| (KJ/m²) | | | | | | | | | | | | |
| Heat distortion | 197 | 197 | 199 | 198 | 200 | 200 | 196 | 196 | 195 | 196 | 196 | 197 |
| temperature at 1.82 | | | | | | | | | | | | |
| MPa (° C.) | | | | | | | | | | | | |

TABLE 4

| | Comp. | | Comp. | |
|---|---|---|---|---|
| | Ex. 18 | Ex. 9 | Ex. 19 | Ex. 10 |
| Polyamide B | 58.94 | 58.55 | 43.94 | 43.55 |
| Polyamide E | — | — | 15 | 15 |
| Kaolin | 25 | 25 | 25 | 25 |
| Glass fibers | 15 | 15 | 15 | 15 |
| Silane | 0.31 | 0.31 | 0.31 | 0.31 |
| Irgafos ® 168 | 0.25 | 0.25 | 0.25 | 0.25 |
| Naugard ® 445 | 0.5 | 0.5 | 0.5 | 0.5 |
| Trimellitic anhydride | — | 0.39 | — | 0.39 |
| Melt Point, 1^{st} cycle, (° C.) | 264 | 263 | 260 | 261 |
| Melt viscosity (P · s) | 310 | 203 | 248 | 238 |
| Tensile strength (MPa) | 134 | 136 | 139 | 136 |
| Elongation at Break (%) | 2.8 | 2.4 | 2.6 | 2.3 |
| Tensile Modulus (GPa) | 8.2 | 8.5 | 8.3 | 8.5 |
| Notched Charpy impact strength | 3.6 | 3.5 | 3.5 | 3 |
| (KJ/m²) | | | | |
| Heat Distortion Temperature at | 241 | 238 | 221 | 219 |
| 1.82 MPa (° C.) | | | | |

Ingredient quantities are given in weight percent based on the total weight of the composition.

TABLE 5

| | Ex. A | Ex. B | Ex. C | Ex. D | Ex. E | Ex. G | Ex. H | Ex. I | Ex. J | Ex. K |
|---|---|---|---|---|---|---|---|---|---|---|
| Polyamide: | A + D | B | B | B + E (7:1) | B + E | B + E | B + E (3:1) | C + E | C | C |
| | (3:1) | | | | (3:1) | (3:1) | | (3:1) | | |
| Mineral filler: | CaCO₃ A | kaolin | wollastonite | wollastonite | CaCO₃ A | kaolin | wollastonite | CaCO₃ A | CaCO₃ A | CaCO₃ B |
| MV with no | 211 | 310 | 211 | 208 | 267 | 248 | 175 | 240 | 195 | 207 |
| carboxylic acid | | | | | | | | | | |
| compound | | | | | | | | | | |
| (Pa-s) | | | | | | | | | | |
| Phthalic | 52% | 72% | 74% | 77% | 76% | 94% | 97% | 81% | 53% | 83% |
| anhydride | | | | | | | | | | |
| Phthalic acid | — | — | — | — | — | — | — | — | 83% | 73% |
| Trimellitic | — | 65% | 69% | 70% | — | 96% | 93% | — | — | — |
| anhydride | | | | | | | | | | |
| Terephthalic | 109% | 59% | 103% | 87% | 108% | 113% | 99% | 113% | — | — |
| acid | | | | | | | | | | |
| Isophthalic acid | — | — | 79% | 73% | — | — | 107% | — | — | — |
| Maleic acid | — | — | — | — | — | — | — | — | 116% | 118% |
| Maleic | — | — | — | — | — | — | — | — | 131% | — |
| anhydride | | | | | | | | | | |
| Fumaric acid | — | — | — | — | — | — | — | — | 101% | 103% |
| Succinic acid | — | 66% | 88% | 52% | — | 106% | 95% | — | — | — |
| Succinic | — | 68% | 88% | 68% | — | 103% | 117% | — | — | — |
| anhydride | | | | | | | | | | |
| Citric acid | — | 79% | 80% | 110% | — | 93% | 114% | — | — | — |
| Adipic acid | 73% | 64% | 80% | 63% | 88% | 94% | 99% | 98% | — | — |

What is claimed is:

1. A process for the preparation of a mineral-reinforced composition exhibiting high melt flow, comprising melt-blending a thermoplastic polymer comprising at least one polyamide and/or at least one polyester with about 0.1 to about 10 weight percent, based on the total weight of polyamide and/or polyester, of at least one aromatic dicarboxylic acid, aromatic dicarboxylic acid anhydride, aromatic tricarboxylic acid, and/or aromatic tricarboxylic acid anhydride with at least one mineral filler; and optionally, with one or more additional components, wherein the aromatic dicarboxylic acid, aromatic dicarboxylic acid anhydride, aromatic tricarboxylic acid, and/or aromatic tricarboxylic acid anhydride has a melting point that is no greater than the onset temperature of the melting point endotherm of the polyamide or polyester.

2. The process of claim 1, wherein the aromatic dicarboxylic acid, aromatic dicarboxylic acid anhydride, aromatic tricarboxylic acid, and/or aromatic tricarboxylic acid anhydride is present in about 0.05 to about 2 weight percent, based on the total weight of polyamide and/or polyester.

3. The process of claim 1, wherein the aromatic dicarboxylic acid, aromatic dicarboxylic acid anhydride, aromatic tricarboxylic acid, and/or aromatic tricarboxylic acid anhydride is present in about 0.1 to about 1 weight percent, based on the total weight of polyamide and/or polyester.

4. The process of claim 1, wherein the aromatic dicarboxylic acid is phthalic acid.

5. The process of claim 1, wherein the aromatic dicarboxylic acid anhydride is phthalic anhydride.

6. The process of claim 1, wherein the aromatic tricarboxylic acid anhydride is trimellitic anhydride.

7. The process of claim 1, wherein the polyamide is selected from one or more of the groups consisting of polyamide 6; polyamide 6,6; polyamide 4,6; polyamide 6,10; polyamide 6,12; polyamide 11; and polyamide 12.

8. The process of claim 1, wherein the polyamide is selected from one or more of the groups consisting of poly(m-xylylene adipamide), poly(dodecamethylene terephthalamide), poly(decamethylene terephthalamide), poly(nonamethylene terephthalamide), hexamethylene adipamide/hexamethylene terephthalamide copolyamide; and hexamethylene terephthalamide/2-methylpentamethylene terephthalamide copolyamide.

9. The process of claim 1, wherein the polyester is selected from one or more of the group consisting of poly(ethylene terephthalate), poly(1,4-butylene terephthalate), poly(propylene terephthalate), poly(1,4-butylene naphthalate), poly(ethylene naphthalate), and poly(1,4-cyclohexylene dimethylene terephthalate).

10. The process of claim 1, wherein the mineral filler is selected from one or more of calcium carbonate, talc, mica, calcined clay, magnesium sulfate, lizardite, ceramic beads, fumed silica, calcium hydroxide, barite, feldspar, graphite, perlite, vermiculite, wollastonite, and attapulgite.

11. The process of claim 10, wherein the mineral filler is calcium carbonate.

12. The process of claim 1, wherein the composition further comprises a reinforcing agent.

13. The process of claim 12, wherein the reinforcing agent is one or more of glass fibers, carbon fibers, wollastonite, and aramids.

14. An article molded from the composition produced by the process of claim 1.

15. The article of claim 14 in the form of a computer housing, a fan, a fan shroud, a wheel cover, or a switch housing.
